(19) United States
(12) Patent Application Publication
(10) Pub. No.: US 2010/0177356 A1
(43) Pub. Date: Jul. 15, 2010

(54) METHOD AND APPARATUS FOR PROCESSING IMAGE IN DIGITAL PRINTER

(75) Inventors: Dong-keun Nam, Seongnam-si (KR); Jin-yong Ahn, Suwon-si (KR); Sun-il Choi, Uiwang-si (KR); Jung-kil Kim, Suwon-si (KR); Ju-ho Hyun, Suwon-si (KR); Eun-gyun Kim, Busan Metropolitan City (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/502,701

(22) Filed: Jul. 14, 2009

(30) Foreign Application Priority Data
Jan. 9, 2009 (KR) 10-2009-0001943

(51) Int. Cl. H04N 1/405; H04N 1/60

(52) U.S. Cl. 358/3.06; 358/1.9; 358/1.13

(57) ABSTRACT

Provided are a method and apparatus for processing image data in a printer, in which page description language (PDL) data is analyzed and generated as standard color data, the generated standard color data is converted to a plurality of printer outputting colors, image conversion processes are parallely performed on the printer outputting colors, and printing data is generated on a page-by-page basis based on the printer outputting colors to which the image conversion processes are performed.

### CROSS-REFERENCE TO RELATED PATENT APPLICATION

This application claims the benefit of Korean Patent Application No. 10-2009-0001943, filed on Jan. 9, 2009, in the Korean Intellectual Property Office, the disclosure of which is incorporated herein in its entirety by reference.

### BACKGROUND OF THE INVENTION

1. Field of the Invention

The present invention relates to a digital printer, and more particularly, to a method and apparatus for processing an image in a digital printer, whereby a data processing speed of a raster image processing (RIP) module is improved in the digital printer.

2. Description of the Related Art

Generally, digital printers transmit and receive printing data from hosts such as personal computers (PCs), and then print the printing data onto printing paper.

When a user selects a printing program from among application programs of a host, a printer driver converts information regarding a corresponding page into page description language (PDL) data. In this regard, the PDL data includes various pieces of information regarding an image, such as the location, size and encoding scheme of the image and image data.

A digital printer converts PDL data to image data through a raster image processing (RIP) module. However, it takes a long time for the RIP module to perform its operation, in a software process of the digital printer. Thus, there is a need to improve a data processing speed of the RIP module of the digital printer.

### SUMMARY OF THE INVENTION

The present invention provides a method and apparatus for processing an image in a digital printer, whereby a data processing speed of a raster image processing (RIP) module is improved in the digital printer.

According to an aspect of the present invention, there is provided a method of processing an image in a printer, including generating standard color data by parsing page description language (PDL) data on a page-by-page basis; converting the standard color data to a plurality of printer outputting colors; parallely performing image conversion processes on the plurality of printer outputting colors; and generating printing data on a page-by-page basis, based on the printer outputting colors to which the image conversion process is performed.

According to another aspect of the present invention, there is provided an apparatus for processing an image in a printer, including a page description language (PDL) parser unit parsing PDL data received from a host to generate a red, green and blue (RGB) color signal; an imager converter converting the RGB color signal generated by the PDL parser unit to cyan, magenta, yellow and black (CMYK) color signals, and parallely performing image conversion processes on the CMYK color signals; and a rendering unit generating printing data on a page-by-page basis, based on the RGB color signal generated by the PDL parser unit and the CMYK color signals processed by the image converter.

According to another aspect of the present invention, there is provided a printer including a raster imager processor parsing page description language (PDL) data received from a host to generate a red, green and blue (RGB) color signal, converting the RGB color signal generated to cyan, magenta, yellow and black (CMYK) color signals, and parallely performing image conversion processes on the CMYK color signals to generate printing data on a page-by-page basis; and a printer engine unit performing a printing operation according to the printing data generated by the raster image processor to form an output image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a printer system according to an exemplary embodiment;

FIG. 2 is a detailed diagram of a printer of FIG. 1, according to an exemplary embodiment;

FIG. 3 is a detailed diagram of a raster image processor of FIG. 2, according to an exemplary embodiment;

FIG. 4 is a detailed diagram of an image converter of FIG. 3, according to an exemplary embodiment; and

FIG. 5 is a flowchart of a method of processing an image in a digital printer, according to an exemplary embodiment.

### DETAILED DESCRIPTION OF THE INVENTION

Hereinafter, the present invention will be described in detail by explaining exemplary embodiments of the invention with reference to the attached drawings.

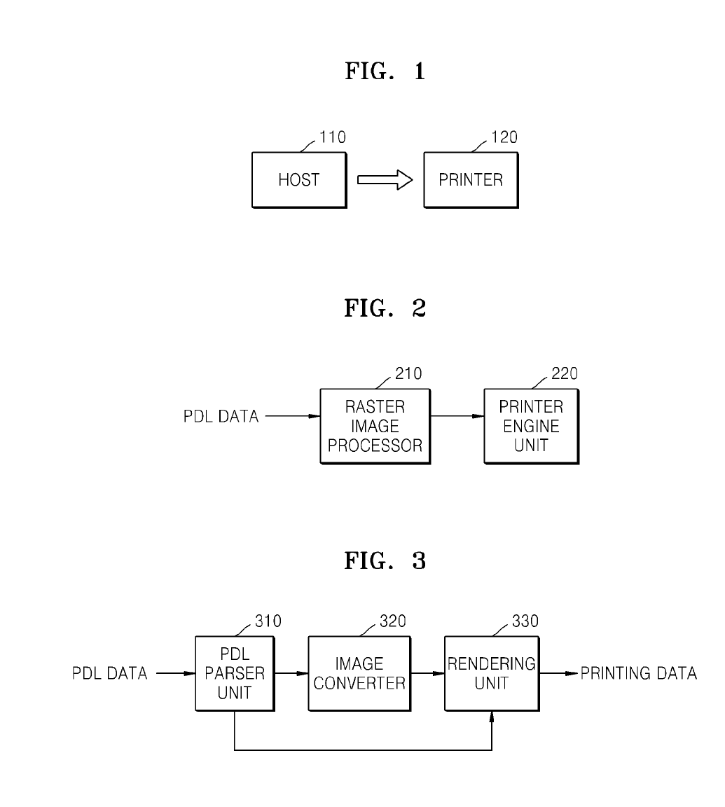

FIG. 1 is a block diagram of a printer system according to an exemplary embodiment;

Referring to FIG. 1, the printer system according to the present embodiment includes a host 110 and a printer 120.

When the host 110 selects a printing program from among application programs, a corresponding page data is converted to page description language (PDL) data, and the PDL data is transmitted to the printer 120 in a sequence of bytes.

The printer 120 analyzes the PDL data received from the host 110, and converts the PDL data to image data that is in a printable form. In this regard, the printer 120 parallely performs image conversion processes (e.g., a halftoning process) on cyan, magenta, yellow and black (CMYK) color signals.

FIG. 2 is a detailed diagram of the printer 120 of FIG. 1, according to an exemplary embodiment.

Referring to FIG. 2, the printer 120 according to the present embodiment includes a raster image processor 210 and a printer engine unit 220.

The raster image processor 210 analyzes the PDL data, extracts standard color data, converts the standard color data into a plurality of printer outputting colors, parallely performs the image conversion processes on the printer outputting colors, and generates printing data on a page-by-page basis, based on the printer outputting colors to which the image conversion process is performed.

The printer engine unit 220 forms an output image by performing a printing operation including exposure, development, transcription and fixation, according to the printing data generated by the raster image processor 210.

FIG. 3 is a detailed diagram of the raster image processor 210 of FIG. 2, according to an exemplary embodiment.

Referring to FIG. 3, the raster image processor 210 according to the present embodiment includes a PDL parser unit 310, an image converter 320, and a rendering unit 330.

The PDL parser unit 310 parses the PDL data, received from the host 110, on a page-by-page basis into graphic data, font data and image information, and expresses the PDL data as red, green and blue (RGB) color signals.

The image converter 320 converts the RGB color signals expressed by the PDL parser unit 310 to CMYK color signals by using a look-up table, and parallely performs the image conversion processes on the CMYK color signals.

In this regard, the image conversion processes may include rotating, scaling and halftoning processes. If necessary, the rotating and scaling processes may be omitted.

The rotating process is performed by rotating image data by a predetermined angle.

The scaling process is performed by changing the size of an image since an original image and a printing image may be different in terms of their size.

The halftoning process is performed by converting 8 bit image data to 1 bit image data. That is, a digital printer expresses a color image displayed on a monitor as two values of black and white only. At this time, in order to output a color image on a monitor in various brightnesses, the digital printer or a personal computer (PC) performs a predetermined operation for converting an input image to a binary image. That is, the digital printer or the PC converts an image of a pixel into an image with a grayscale in the range of 0 to 255, and converts the image with a grayscale to a binary image. In this regard, an image having a grayscale in the range of 0 to 255 is referred to as a grayscale image, and an operation for converting the grayscale image to the binary image is referred to as halftoning.

Generally, it takes the longest time for a raster image processing (RIP) module to perform an image conversion process such as halftoning, in an entire process of the digital printer.

The rendering unit 330 generates printing data on a page-by-page basis by using the RGB color signals generated by the PDL parser unit 310 and the CMYK color signals processed by the image converter 320.

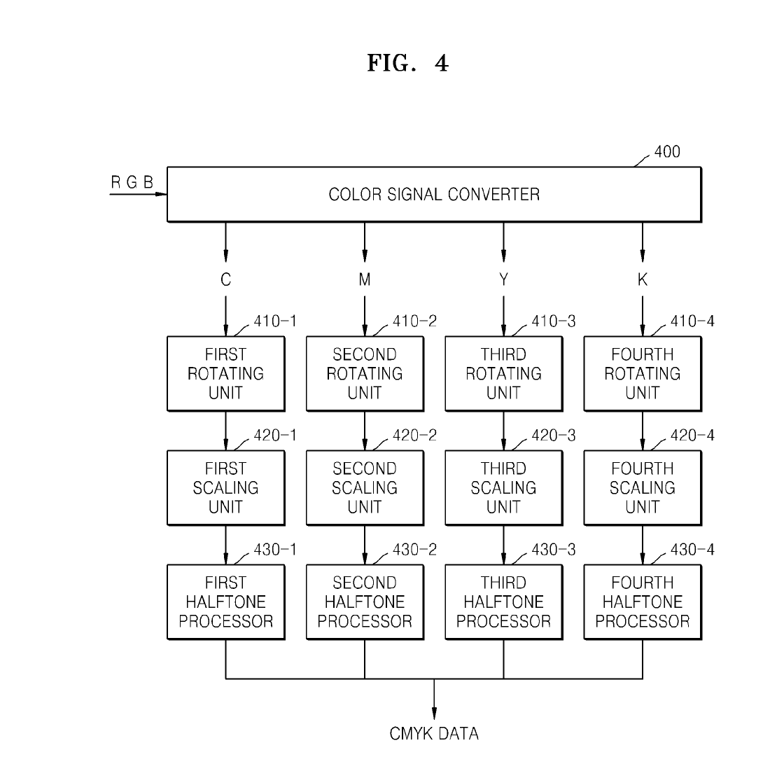

FIG. 4 is a detailed diagram of the image converter 320 of FIG. 3, according to an exemplary embodiment.

A color signal converter 400 converts the RBG color signal input thereto into the CMYK color signals corresponding to the printer outputting colors by using a color look-up table.

A first rotating unit 410-1, a second rotating unit 410-2, a third rotating unit 410-3, and a fourth rotating unit 410-4 parallely perform rotating processes on the CMYK color signals.

A first scaling unit 420-1, a second scaling unit 420-2, a third scaling unit 420-3, and a fourth scaling unit 420-4 parallely perform image scaling processes on the CMYK color signals.

A first halftone processor 430-1, a second halftone processor 430-2, a third halftone processor 430-3, and a fourth halftone processor 430-4 parallely perform halftoning processes on the CMYK color signals

The rotating and scaling processes may be omitted, if necessary.

Generally, the image conversion processes are repeatedly performed on the CMYK color signals in the order stated. However, according to the presented embodiments, a data processing speed of the RIP module may be improved by parallely performing the image conversion processes on the CMYK color signals.

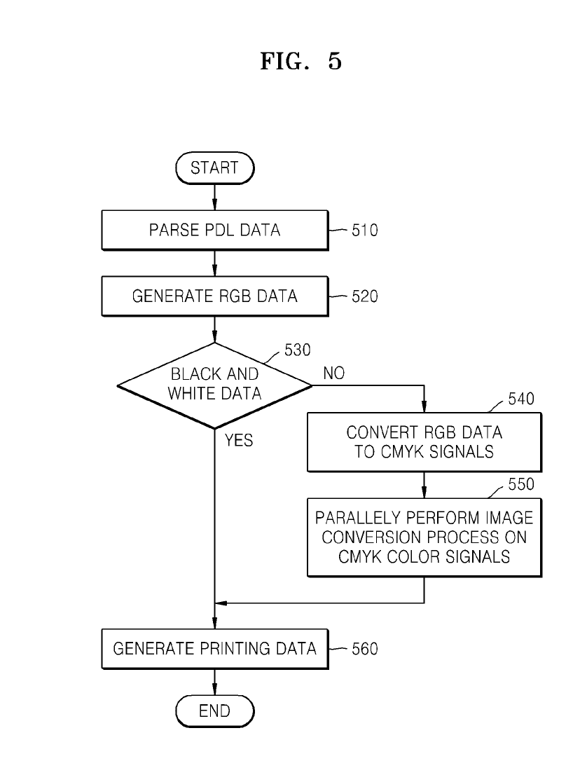

FIG. 5 is a flowchart of a method of processing an image in a digital printer, according to an embodiment.

PDL data input from a host is parsed (operation 510) so that RGB color data corresponding to standard color data is generated (operation 520).

Then, it is checked whether the RGB color data is black and white data (operation 530). For example, when R, G and B level values are 0, 0, and 0, respectively, a corresponding color is white. When R, G and B level values are 255, 255, and 255, respectively, a corresponding color is black.

When the RGB color data is not black and white data, the RGB color data is converted to the CMYK color data corresponding to a plurality of printer outputting colors using a color look-up table (operation 540).

Then, image conversion processes are parallely performed on CMYK color signals (operation 550). In this regard, the image conversion process may include rotating, scaling and halftoning processes.

A rendering operation is performed using the black and white signal and the CMYK color data to which the image conversion process is performed, and then printing data is generated on a page-by-page basis (operation 560).

According to the presented exemplary embodiments, a printing speed may be increased in a multi-core/multi-processor-based printer environment by parallely performing the image conversion processes on components of C, M, Y and K colors.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of processing an image in a printer, comprising:
generating standard color data by parsing page description language (PDL) data on a page-by-page basis;
converting the standard color data to a plurality of printer outputting colors;
parallely performing image conversion processes on the plurality of printer outputting colors; and
generating printing data on a page-by-page basis, based on the printer outputting colors to which the image conversion process is performed.

2. The method of claim 1, wherein the converting comprises converting red, green and blue (RGB) data generated from the PDL data to cyan, magenta, yellow and black (CMYK) data.

3. The method of claim 1, wherein the image conversion processes comprises parallely performing the image conversion processes on cyan, magenta, yellow and black (CMYK) color signals.

4. The method of claim 1, wherein the image conversion process comprises parallely performing halftoning processes on the plurality of printer outputting colors.

5. An apparatus for processing an image in a printer, comprising:
a page description language (PDL) parser unit that parses PDL data received from a host to generate a red, green and blue (RGB) color signal;
an imager converter that converts the RGB color signal generated by the PDL parser unit to cyan, magenta, yellow and black (CMYK) color signals, and that parallely performs image conversion processes on the CMYK color signals; and
a rendering unit that generates printing data on a page-by-page basis, based on the RGB color signal generated by the PDL parser unit and the CMYK color signals processed by the image converter.

6. The apparatus of claim 5, wherein the image converter comprises:
a color signal converter that converts the RGB color signal to CMYK color signals corresponding to printer outputting colors by using a color look-up table; and
a halftoning processor that parallely performs halftoning processes on the CMYK color signal.

7. The apparatus of claim 6, wherein the image converter further comprises:
a rotating unit that parallely performs rotating processes on the CMYK color signals acquired from the color signal converter; and
a scaling unit that parallely performs scaling processes on the CMYK color signals acquired from the color signal converter.

8. A printer comprising:
a raster imager processor that parses page description language (PDL) data received from a host to generate a red, green and blue (RGB) color signal, that converts the RGB color signal generated to cyan, magenta, yellow and black (CMYK) color signals, and that parallely performs image conversion processes on the CMYK color signals to generate printing data on a page-by-page basis; and
a printer engine unit that performs a printing operation according to the printing data generated by the raster image processor to form an output image.

9. A computer readable recording medium having recorded thereon a program for executing a method of processing an image in a printer, the method comprising:
generating standard color data by parsing a page description language (PDL) data on a page-by-page basis;
converting the standard color data to a plurality of printer outputting colors;
parallely performing image conversion processes on the plurality of printer outputting colors; and
generating printing data on a page-by-page basis, based on the printer outputting colors to which the image conversion process is performed.

10. A method of processing an image in a printer, comprising:
converting a standard color signal to a plurality of printer color signals corresponding to printer outputting colors;
parallely performing, by at least one processor, an image conversion process on each of the plurality of printer color signals; and
generating printing data based on the processed printer color signals.

11. The method of claim 10, wherein the standard color signal is a red, green and blue (RGB) color signal and the plurality of printer color signals are cyan, magenta, yellow and black (CMYK) color signals.

12. The method of claim 10, wherein the image conversion process comprises a halftoning process.

13. The method of claim 12, wherein the image conversion process further comprises a rotating process and a scaling process.

14. The method of claim 10, wherein the image conversion process is parallely performed by at least one multi-core processor.

15. The method of claim 10, wherein the image conversion process is parallely performed by a plurality of processors.
